(19) United States
(12) Patent Application Publication
(10) Pub. No.: US 2021/0333649 A1
(43) Pub. Date: Oct. 28, 2021

(54) PIXEL STRUCTURE AND LIQUID CRYSTAL DISPLAY PANEL

(71) Applicant: SHENZHEN CHINA STAR OPTOELECTRONICS SEMICONDUCTOR DISPLAY TECHNOLOGY CO., LTD., Shenzhen (CN)

(72) Inventor: Wu CAO, Shenzhen (CN)

(73) Assignee: SHENZHEN CHINA STAR OPTOELECTRONICS SEMICONDUCTOR DISPLAY TECHNOLOGY CO., LTD., Shenzhen (CN)

(21) Appl. No.: 16/626,537

(22) PCT Filed: Nov. 19, 2019
(86) PCT No.: PCT/CN2019/119395

§ 371 Date: Dec. 25, 2019

(30) Foreign Application Priority Data
Oct. 21, 2019 (CN) 201911000293.2

(51) Int. Cl. G02F 1/1343; G02F 1/1368; G02F 1/1362

(52) U.S. Cl. CPC G02F 1/134309; G02F 1/136286; G02F 1/1368

(57) ABSTRACT

A pixel structure is arranged on a substrate, and includes a pixel area disposed on the substrate. The pixel area is defined with a long axis and a short axis and includes a main pixel area and a subpixel area. A plurality of pixel electrodes are disposed on the main pixel area and the subpixel area. The pixel electrodes each include a plurality of slits spaced apart from and parallel with each other. The slits located in at least one of the main pixel area and the subpixel area are disposed at a first angle with respect to the short axis or the long axis, and the first angle is less than 45 degrees.

### BACKGROUND OF INVENTION

### 1. Field of Invention

The present invention relates to a technical field of displays, and particularly to, a pixel structure and a liquid crystal display panel.

### 2. Related Art

Display technology development is ever-changing. Liquid crystal displays have advantages of low voltage operation, no radiation scattering, being light weight, and being small-sized. They have been widely used in markets for years, and are still the mainstream of displays. Currently, liquid crystal display technologies that can meet requirements of wide viewing angles include twisted nematic (TN) liquid crystals with wide viewing angle films, in-plane switching (IPS) liquid crystal displays, multi-domain vertical alignment (MVA) liquid crystal displays, and so on.

Conventional liquid crystal display panels includes array substrates and color filters (or color filter substrates) fabricated in a front-stage array process, and liquid crystals injected in the array substrates and the color filter substrates combined together in a middle case-assembly process, and fabricated panels are assembled with backlight modules, panel drive circuits, and frames in a rear-stage modular process. Pixel structures of liquid crystal displays include at least one scan line, at least one data line, a switch component, and a pixel electrode. The pixel electrode has a plurality of slits, and structural arrangement of the slits will affect specific alignment direction of liquid crystal molecules and determine viewing angles of display panels. However, arrangement of slit structures of conventional pixel electrodes can only provide certain, limited wide viewing angles, giving rise to a weakness of liquid crystal displays in high-end products.

### SUMMARY OF INVENTION

An object of the present invention is to provide a pixel structure and a liquid crystal display panel to reduce differences in liquid crystal components at a wide viewing angle and a front viewing angle, thereby to improve an optical difference between projections at the wide viewing angle and the front viewing angle, and to enhance display performance at different viewing angles.

In order to achieve the above-mentioned object, the present invention provides a pixel structure, arranged on a substrate, and the pixel structure comprising a pixel area disposed on the substrate, wherein the pixel area is defined with a long axis and a short axis and comprises a main pixel area and a subpixel area; and a plurality of pixel electrodes disposed on the main pixel area and the subpixel area, wherein the pixel electrodes each comprise a plurality of slits spaced apart from and parallel with each other, the slits located in at least one of the main pixel area and the subpixel area are disposed at a first angle with respect to the short axis or the long axis, and the first angle is less than 45 degrees.

According to one aspect of the present invention, the first angle is between 30 degrees and 45 degrees.

According to another aspect of the present invention, one of the pixel electrodes located in the main pixel area has a voltage difference different from a voltage difference of another one of the pixel electrodes located in the subpixel area.

According to another aspect of the present invention, a first switch element, a second switch element, and a third switch element are disposed between the main pixel area and the subpixel area, wherein the first switch element is configured to control the voltage difference of the pixel electrode in the main pixel area, the second switch element is configured to control the voltage difference of the pixel electrode in the subpixel area, and the third switch element is configured to process leakage of the pixel electrode in the subpixel area.

According to another aspect of the present invention, the pixel electrodes of the main pixel area and the subpixel area each comprise a first trunk portion and a second trunk portion both disposed in a cross-like arrangement, and each of the main pixel area and the subpixel area is divided into four divided sub-areas by the first trunk portion and the second trunk portion, wherein the slits located at opposite sides of the first trunk portion are symmetrically disposed, and the slits located at opposite sides of the second trunk portion are symmetrically disposed.

According to another aspect of the present invention, the slits disposed on at least one of the main pixel area and the subpixel area are disposed at the first angle with respect to the short axis and extend in a direction opposite to the long axis.

According to another aspect of the present invention, the pixel area is composed of a red subpixel area, a green subpixel area, and a blue subpixel area each comprising the main pixel area and the subpixel area, wherein at least the slits of the blue subpixel area are disposed at the first angle with respect to the short axis or the long axis.

According to another aspect of the present invention, the pixel structure further comprises a plurality of scan lines and a plurality of data lines, wherein opposite ends of the pixel area are configured with the scan lines, and at least a switch element is disposed on an end between the main pixel area and the subpixel area.

According to another aspect of the present invention, the long axis of the pixel area is defined as a Y-axis, the short axis is defined as an X-axis, and the main pixel area and the subpixel area are disposed sequentially in a direction of the long axis, wherein the slits of at least one of the main pixel area and the subpixel area are disposed at a second angle with respect to the short axis or the long axis, and the second angle is greater than the first angle.

The present invention further provides a liquid crystal display panel, comprising a plurality of the pixel structures of claim 1, wherein the pixel structures are arranged on a substrate; an opposite substrate; and a liquid crystal layer disposed between the substrate and the opposite substrate.

The present invention further provides a pixel structure, arranged on a substrate, and the pixel structure comprising a pixel area disposed on the substrate, wherein the pixel area is defined with a long axis and a short axis and comprises a main pixel area and a subpixel area; and a plurality of pixel electrodes disposed on the main pixel area and the subpixel area, wherein the pixel electrodes each comprise a plurality of slits spaced apart from and parallel with each other, the slits located in at least one of the main pixel area and the subpixel area are disposed at a first angle with respect to the short axis or the long axis, and the first angle is between 30 degrees and 45 degrees; wherein the pixel electrodes of the main pixel area and the subpixel area each comprise a first trunk portion and a second trunk portion both disposed in a cross-like arrangement, and each of the main pixel area and the subpixel area is divided into four divided sub-areas by the first trunk portion and the second trunk portion, wherein the slits located at opposite sides of the first trunk portion are symmetrically disposed, and the slits located at opposite sides of the second trunk portion are symmetrically disposed.

A pixel structure of the present invention is configured in combination with multi-domain vertical alignment architecture, and provides ITO electrode structures for four different domains according to a main pixel area and a subpixel area each having a voltage difference and light efficiency different from each other. By reducing an angle of electrode slits after angle adjustment of slits, light transmittance or liquid crystal efficiency is reduced at a front viewing angle. At this time, a projection of liquid crystal components seen from left and right sides of a display panel at a wide viewing angle is less different from being seen at the front viewing angle, thereby improving an optical difference between the two viewing angles, and achieving a purpose of increasing viewing angles, as well as improving display performance at different viewing angles, and thereby to effectively overcome a problem of color shift at a wide viewing angle in prior art.

### BRIEF DESCRIPTION OF DRAWINGS

FIG. 1 is a schematic structural view of a pixel structure of a preferable embodiment of the present invention.

FIGS. 2A-2C are schematic structural views of a pixel structure of different embodiments of the present invention.

FIG. 3 is another schematic structural view of a pixel structure of the present invention.

FIG. 4 is a schematic structural view of a pixel structure including a red subpixel area, a green subpixel area, and a blue subpixel area of the present invention.

FIGS. 5A-5C are schematic circuit views showing a pixel structure of the present invention applicable to different types of multi-domain vertical alignment architecture.

FIG. 6 is a schematic structural view of a liquid crystal display panel of a preferable embodiment of the present invention.

### DESCRIPTION OF PREFERRED EMBODIMENTS

The following embodiments are referring to the accompanying drawings for exemplifying specific implementable embodiments of the present invention. Directional terms described by the present invention, such as upper, lower, front, back, left, right, inner, outer, side, etc., are only directions by referring to the accompanying drawings, and thus the used directional terms are used to describe and understand the present invention, but the present invention is not limited thereto.

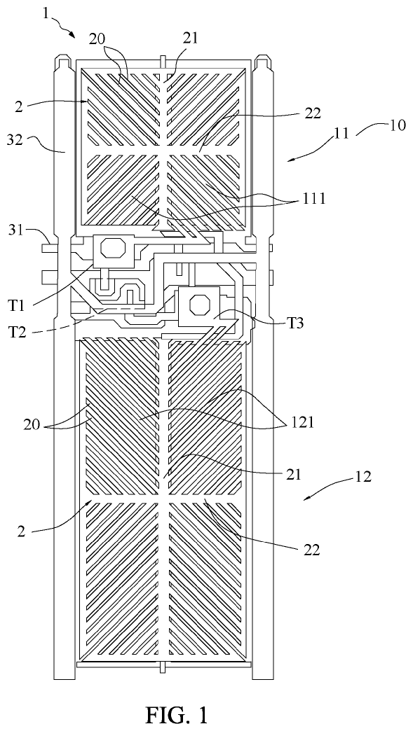

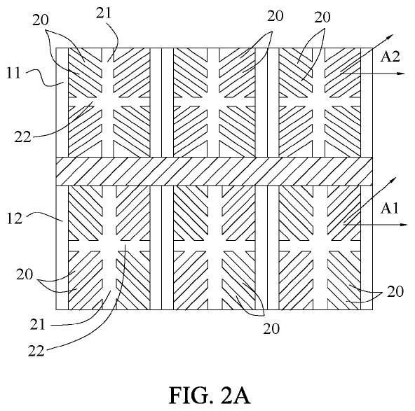

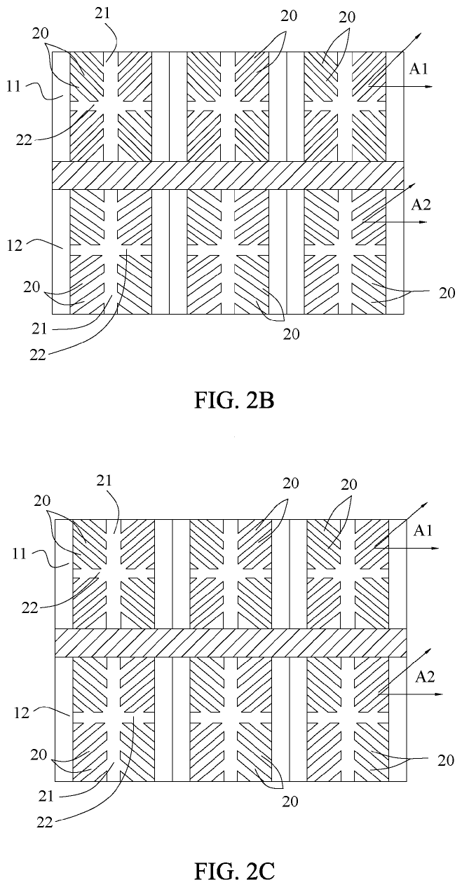

The present invention relates to a pixel structure of a liquid crystal display panel, and particularly, to a pixel structure of a multi-domain vertical alignment liquid crystal display. FIG. 1 is a schematic structural view of a pixel structure of a preferable embodiment of the present invention, wherein a number of the pixel structure described below is one as an example. The present invention provides a pixel structure 1 arranged on a substrate 101 (as shown in FIG. 6). The pixel structure includes a pixel area 10 and a plurality of pixel electrodes 2. The pixel area 10 includes a main pixel area 11 and a subpixel area 12 and is defined with a long axis and a short axis. Specifically, the long axis and the short axis are defined according to a horizontal direction of the display, wherein the long axis of the pixel area is defined as a Y-axis and the short axis is defined as an X-axis. The main pixel area 11 and the subpixel area 12 are disposed sequentially in a direction of the long axis (i.e. Y-axis). Furthermore, each of opposite ends of the pixel area 10 is configured with scan lines 31, and at least a switch element is disposed on an end between the main pixel area 11 and the subpixel area 12. A black matrix (BM) is provided at positions corresponding to metal wirings, such as the data lines and the scan lines (as shown in FIGS. 2A-2C). In this embodiment, the switch element is a thin-film transistor (TFT).

Please continue referring to FIG. 1. The pixel electrodes 2 are disposed on the main pixel area 11 and the subpixel area 12, and each of the electrodes 2 includes a first trunk portion 21 and a second trunk portion 22 both disposed in a cross-like arrangement in the main pixel area 11 and the subpixel area 12. Each of the main pixel area 11 and the subpixel area 12 is divided into four divided sub-areas 111 and 121 by the first trunk portion 21 and the second trunk portion 22. That is, the main pixel area 11 and the subpixel area 12 cooperatively constitute a two-area eight-domain vertical alignment (VA) pixel structure, thereby to achieve better wide viewing angle performance and to solve a color cast problem. In this preferable embodiment, the pixel electrodes 2 are made of indium tin oxide (ITO). The pixel electrodes 2 each include a plurality of slits 20 spaced apart from and parallel with each other, so that an electrode is formed between either two of the slits 20. Specifically, the slits 20 located at opposite sides of the first trunk portion 21 are symmetrically disposed, and the slits 20 located at opposite sides of the second trunk portion 22 are symmetrically disposed. That is, the divided sub-areas 111 and 121 disposed at upper, lower, left, and right locations constitute a pixel electrode having an approximately pozidrivshape, respectively.

Please continue referring to FIG. 1. A first switch element T1, a second switch element T2, and a third switch element T3 are disposed between the main pixel area 11 and the subpixel area 12. The first switch element T1 is configured to control a voltage difference of the pixel electrode in the main pixel area 11, the second switch element T2 is configured to control a voltage difference of the pixel electrode in the subpixel area 12, and the third switch element T3 is configured to process leakage of the pixel electrode in the subpixel area 12, thereby to enable the voltage difference in the subpixel area 12 to be less than the voltage difference in the main pixel area 11. Specifically, a voltage applied to the pixel electrode of the main pixel are 11 is different from a voltage of the pixel electrode of the sub pixel region 12. By adjusting different voltage differences between the main pixel area 11 and the subpixel area 12 through a TFT, light efficiency of the overall liquid crystal display can be improved.

Tilt angles of liquid crystal molecules are affected by angles of slits of pixel electrodes. An angle of silts of a pixel electrode is generally 45 degrees with respect to a horizontal axis to fully achieve high liquid crystal efficiency, that is, a significant increase in light transmittance, thereby to reduce requirements and costs for backlight brightness. However, because a 45° configuration of the slits, display performance of a display panel on a large viewing angle is poor. The pixel structure of the present invention is provided to overcome the above-mentioned disadvantages. FIGS. 2A-2C are schematic structural views of a pixel structure of different embodiments of the present invention, wherein the pixel structure is applicable to liquid crystal displays having an eight-domain vertical alignment structure. In this preferable embodiment, in the pixel electrode of the present invention, the slits 20 located in at least one of the main pixel area 11 and the subpixel area 12 are disposed at a first angle A1 with respect to the short axis (X-axis), and the first angle is less than 45°. Preferably, the first angle A1 is between 30°-45° to prevent a significant loss of light transmittance from being caused by excessive tilt of liquid crystal molecules

As shown in FIG. 2A, each of the slits 20 in the subpixel area 12 and the short axis (X-axis) form a first angle A1 of 35°, and the slits 20 extend in a direction opposite to the long axis. On the other hand, each of the slits 20 in the main pixel area 11 and the short axis (X-axis) form a second angle A2 of 45°. As shown in FIG. 2B, the slits 20 in the main pixel area 11 each form a first angle A1 of 35° with respect to the short axis and extends in a direction opposite to the long axis (Y-axis). The slits 20 in the subpixel area 12 each form a second angle A2 of 45° with respect to the short axis (X-axis). As shown in FIG. 2C, the slits 20 in both the main pixel area 11 and the subpixel area 12 each form a first angel A1 of 40° with respect to the short axis (X-axis). That is, the first angle A1 of the present invention is less than the second angle A2 by 5°-15°.

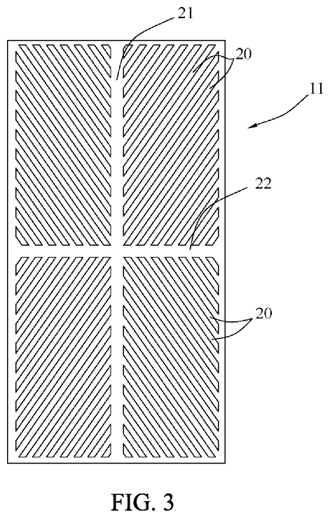

Particularly, in one embodiment, a voltage difference in the main pixel area 11 is large, so that light efficiency is relatively high. On the contrary, a voltage difference in the subpixel area 12 is small, so that light efficiency is relatively low. As a result, making an angle of the slits smaller in the main pixel area 11 can obtain better performance on color deviation and viewing angle in the main pixel area 11 (as shown in FIG. 2B). In another embodiment, an angle of the slits in the subpixel area 12 may also be reduced. However, because light efficiency in the subpixel area 12 is relatively low, reducing the angle of the slits offers only limited benefits for improving viewing angles. Therefore, adjustment of the angle of the slits can be varied according to actual needs. As described above, by adjusting an angle between the slits in the main pixel area 11 or the subpixel area 12 and the X-axis from a predetermined angle of 45° to 35°, display performance of the display panel at viewing angles of left and right sides can be effectively improved. Furthermore, according to different needs, the slits 20 in the main pixel area 11 or the subpixel area 12 may form an angle (as shown in FIG. 3) less than 45° with respect to the long axis (Y-axis) to improve display performance of the display panel at viewing angles of upper and lower sides of the display panel.

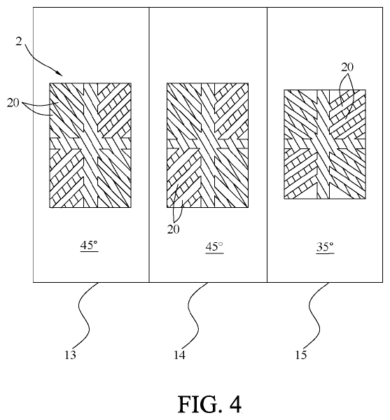

Please refer to FIG. 4. the pixel area 10 of the pixel structure 1 of the present invention includes a red subpixel area 13, a green subpixel area 14, and a blue subpixel area 15 each including the main pixel area and the subpixel area. According to a ratio of light intensity, an angle between the slits 20 in the blue subpixel are 15 and the short axis direction (X-axis) or the long axis (Y-axis) is preferentially reduced. That is, in the pixel structure of the present invention, adjustment of the angle of the slits may be made in only one of three primary colors: the red subpixel area 13, the green subpixel area 14, and the blue subpixel area 15.

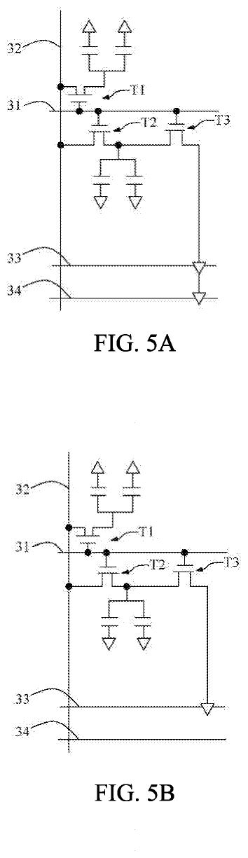

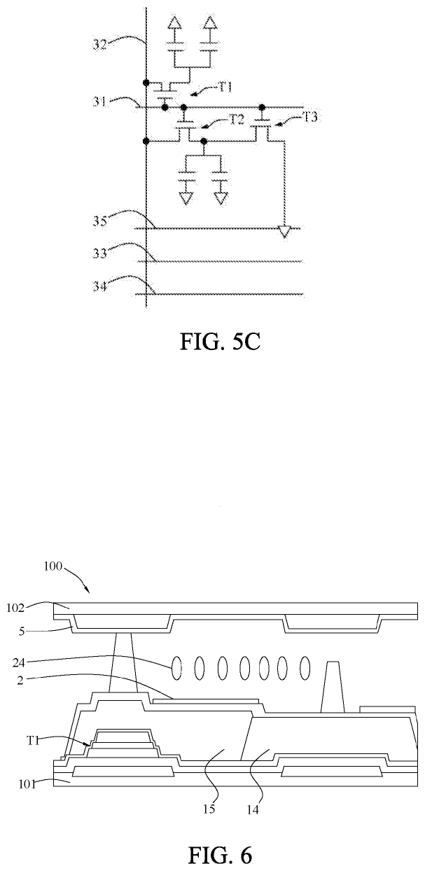

FIGS. 5A-5C are schematic circuit views showing a pixel structure of the present invention applicable to different types of multi-domain vertical alignment architecture. As shown in FIGS. 5A-5C, the pixel structure is applicable to an eight-domain vertical alignment liquid crystal display having a color filter on array (COA) structure. Opposite two sides of the scan lines 31 are configured with the main pixel area 11 and the subpixel area 12, respectively, and the data lines 32 are perpendicular to the scan lines 31. A voltage difference in the subpixel area 12 is adjusted to be less than a voltage difference in the main pixel area 11 under control of the first switch element T1, the second switch element T2, and the third switch element T3, thereby achieving a multi-domain display effect. Specifically, as shown in FIG. 5A, the third switch element T3 is controlled by a bundle of an array substrate common electrode 33 (i.e. array com, ACOM) and an array substrate ITO common electrode 34 (i.e. Data BM Less com, DBS Com). It should be noted that, in COA technology, an indium tin oxide (ITO) common (COM) trace (RGB film layer) above the data lines is an ITO common electrode (CF Com) of an upper substrate. Because a potential setting of the ITO com trace is the same as or close to that of the CF Com, liquid crystals in this area remain an off black state for a long time, thereby to function to shield light and protect a screen. Because conventional data lines are shielded by a BM, the above-mentioned DBS can be sued to replace the use of the BM for data lines, so that it can be understood that data BM less=DBS com. As shown in FIG. 5B, the third switch element T3 is controlled by ACOM, but DBS com is an independent structure. As shown in FIG. 5C, the third switch element T3 is independently controlled by an independent shared common electrode 35 (share com for shore), and other common electrode traces for other functions are all configured with ACOM and DBS and are controlled in combination with each other or controlled independently.

The present invention further provides a liquid crystal display panel 100, and particularly, to a liquid crystal display panel having a COA structure and including the pixel structure of the aforementioned embodiments. The pixel structure 1 is arranged on the substrate 101 including the aforementioned three switch elements, and an opposite substrate 102 disposed facing the substrate 101. A common electrode layer 5 is disposed on a side of the opposite substrate 102 facing the pixel structure 1. A liquid crystal layer 4 is disposed between the substrate 101 and the opposite substrate 102. Other components of the liquid crystal display panel are the same as a structure of a general liquid crystal display panel, and will not be repeated here.

The pixel structure of the present invention is configured in combination with multi-domain vertical alignment architecture, and provides ITO electrode structures for four different domains according to a main pixel area and a subpixel area each having a voltage difference and light efficiency different from each other. By reducing an angle of electrode slits after angle adjustment of slits, light transmittance or liquid crystal efficiency is reduced at a front viewing angle. At this time, a projection of liquid crystal components seen from left and right sides of a display panel at a wide viewing angle is less different from being seen at the front viewing angle, thereby improving an optical difference between the two viewing angles, and achieving a purpose of increasing viewing angles, as well as improving display performance at different viewing angles, and thereby to effectively overcome a problem of color shift at a wide viewing angle in prior art.

Accordingly, although the present invention has been disclosed as a preferred embodiment, it is not intended to limit the present invention. Those skilled in the art without departing from the spirit and scope of the present invention may make various changes or modifications, and thus the scope of the present invention should be after the appended claims and their equivalents.

What is claimed is:

1. A pixel structure, arranged on a substrate, and the pixel structure comprising:
a pixel area disposed on the substrate, wherein the pixel area is defined with a long axis and a short axis and comprises a main pixel area and a subpixel area; and
a plurality of pixel electrodes disposed on the main pixel area and the subpixel area, wherein the pixel electrodes each comprise a plurality of slits spaced apart from and parallel with each other, the slits located in at least one of the main pixel area and the subpixel area are disposed at a first angle with respect to the short axis or the long axis, and the first angle is less than 45 degrees.

2. The pixel structure of claim 1, wherein the first angle is between 30 degrees and 45 degrees.

3. The pixel structure of claim 1, wherein one of the pixel electrodes located in the main pixel area has a voltage difference different from a voltage difference of another one of the pixel electrodes located in the subpixel area.

4. The pixel structure of claim 3, wherein a first switch element, a second switch element, and a third switch element are disposed between the main pixel area and the subpixel area, wherein the first switch element is configured to control the voltage difference of the pixel electrode in the main pixel area, the second switch element is configured to control the voltage difference of the pixel electrode in the subpixel area, and the third switch element is configured to process leakage of the pixel electrode in the subpixel area.

5. The pixel structure of claim 1, wherein the pixel electrodes of the main pixel area and the subpixel area each comprise a first trunk portion and a second trunk portion both disposed in a cross-like arrangement, and each of the main pixel area and the subpixel area is divided into four divided sub-areas by the first trunk portion and the second trunk portion, wherein the slits located at opposite sides of the first trunk portion are symmetrically disposed, and the slits located at opposite sides of the second trunk portion are symmetrically disposed.

6. The pixel structure of claim 5, wherein the slits disposed on at least one of the main pixel area and the subpixel area are disposed at the first angle with respect to the short axis and extend in a direction opposite to the long axis.

7. The pixel structure of claim 1, wherein the pixel area is composed of a red subpixel area, a green subpixel area, and a blue subpixel area each comprising the main pixel area and the subpixel area, wherein at least the slits of the blue subpixel area are disposed at the first angle with respect to the short axis or the long axis.

8. The pixel structure of claim 1, further comprising a plurality of scan lines and a plurality of data lines, wherein opposite ends of the pixel area are configured with the scan lines, and at least a switch element is disposed on an end between the main pixel area and the subpixel area.

9. The pixel structure of claim 1, wherein the long axis of the pixel area is defined as a Y-axis, the short axis is defined as an X-axis, and the main pixel area and the subpixel area are disposed sequentially in a direction of the long axis, wherein the slits of at least one of the main pixel area and the subpixel area are disposed at a second angle with respect to the short axis or the long axis, and the second angle is greater than the first angle.

10. A liquid crystal display panel, comprising:
a plurality of the pixel structures of claim 1, wherein the pixel structures are arranged on a substrate;
an opposite substrate; and
a liquid crystal layer disposed between the substrate and the opposite substrate.

11. A pixel structure, arranged on a substrate, and the pixel structure comprising:
a pixel area disposed on the substrate, wherein the pixel area is defined with a long axis and a short axis and comprises a main pixel area and a subpixel area; and
a plurality of pixel electrodes disposed on the main pixel area and the subpixel area, wherein the pixel electrodes each comprise a plurality of slits spaced apart from and parallel with each other, the slits located in at least one of the main pixel area and the subpixel area are disposed at a first angle with respect to the short axis or the long axis, and the first angle is between 30 degrees and 45 degrees;
wherein the pixel electrodes of the main pixel area and the subpixel area each comprise a first trunk portion and a second trunk portion both disposed in a cross-like arrangement, and each of the main pixel area and the subpixel area is divided into four divided sub-areas by the first trunk portion and the second trunk portion, wherein the slits located at opposite sides of the first trunk portion are symmetrically disposed, and the slits located at opposite sides of the second trunk portion are symmetrically disposed.

12. The pixel structure of claim 11, wherein one of the pixel electrodes located in the main pixel area has a voltage difference different from a voltage difference of another one of the pixel electrodes located in the subpixel area.

13. The pixel structure of claim 12, wherein a first switch element, a second switch element, and a third switch element are disposed between the main pixel area and the subpixel area, wherein the first switch element is configured to control the voltage difference of the pixel electrode in the main pixel area, the second switch element is configured to control the voltage difference of the pixel electrode in the subpixel area, and the third switch element is configured to process leakage of the pixel electrode in the subpixel area.

14. The pixel structure of claim 11, wherein the slits disposed on at least one of the main pixel area and the subpixel area are disposed at the first angle with respect to the short axis and extend in a direction opposite to the long axis.

15. The pixel structure of claim 11, wherein the long axis of the pixel area is defined as a Y-axis, the short axis is defined as an X-axis, and the main pixel area and the subpixel area are disposed sequentially in a direction of the long axis, wherein the slits of at least one of the main pixel area and the subpixel area are disposed at a second angle with respect to the short axis or the long axis, and the second angle is greater than the first angle.
